(19) United States
(12) Patent Application Publication
(10) Pub. No.: US 2014/0174065 A1
(43) Pub. Date: Jun. 26, 2014

(54) HYDRAULIC CONTROL SYSTEM FOR SWING MOTOR

(71) Applicant: CATERPILLAR INC., Peoria, IL (US)

(72) Inventor: Pengfei Ma, Naperville, IL (US)

(73) Assignee: Caterpillar Inc., Peoria, IL (US)

(21) Appl. No.: 13/723,443

(22) Filed: Dec. 21, 2012

(51) Int. Cl. F15B 13/02

(52) U.S. Cl. CPC F15B 13/02
USPC 60/327; 60/421

(57) ABSTRACT

A hydraulic control system for a machine is disclosed. The hydraulic control system includes a swing control valve coupled between the swing motor, the pump and the tank to selectively control a fluid flow between the pump and the swing motor. The hydraulic control system includes a first conduit coupled between a first port of the swing control valve and a first chamber port of the swing motor. Further, a second conduit is coupled between a second port of the swing control valve and a second chamber port of the swing motor. A first chamber valve and a second chamber valve coupled to the first conduit and the second conduit. A controller is configured to selectively move one of the first and second chamber valves to reduce the fluid flow between the swing motor and the tank such that the pressurized flow discharged from the swing motor is directed to an accumulator fluidly coupled to each of the first and second conduits.

### TECHNICAL FIELD

The present disclosure relates generally to a machine having a swing mechanism and particularly to a hydraulic control system for the swing mechanism in the machine.

### BACKGROUND

Swing-type excavation machines, for example hydraulic excavators and front shovels, require significant hydraulic pressure and flow to transfer material from a dig location to a dump location. These machines direct the high-pressure fluid from an engine-driven pump through a swing motor to accelerate a loaded work tool at the start of each swing, and then restrict the flow of fluid exiting the motor at the end of each swing to slow and stop the work tool. The swing motor may be operated by a hydraulic control system employed with an energy recovery system.

One problem associated with this type of hydraulic arrangement involves efficiency. In particular, the fluid exiting the swing motor at the end of each swing is under a relatively high pressure due to deceleration of the loaded work tool. Unless recovered, energy associated with the high-pressure fluid may be wasted. In addition, restriction of this high-pressure fluid exiting the swing motor at the end of each swing can result in heating of the fluid, which must be accommodated with an increased cooling capacity of the machine.

In one example, Japanese patent application 2011/179280 discloses a construction machine which facilitates an effective recovery of energy from a swivel drive mechanism. The construction machine includes a swivel part driven by swivel mechanism and a hydraulic pump driven by an engine. A first hydraulic motor is connected to the hydraulic pump through a first hydraulic circuit, to be driven by hydraulic pressure from the hydraulic pump, driving the swivel mechanism. A second hydraulic motor is connected to an accumulator through a second hydraulic circuit, to be driven by hydraulic pressure from the accumulator, driving the swivel mechanism, while being driven by the driving of the swivel mechanism, generating hydraulic pressure which is accumulated in the accumulator. However, there is still room for improvement in the art.

### SUMMARY

In one aspect, the present disclosure is directed to a hydraulic control system. The hydraulic control system includes a swing motor, a pump, and a tank. A swing control valve coupled between the swing motor, the pump and the tank to selectively control a fluid flow between the pump and the swing motor. Further, the swing control valve includes a first port and a second port. The swing control valve is movable from a neutral position, where the fluid flow is inhibited, to either a first working position, where the first port is in fluid communication with a first chamber port of the swing motor and the pump. Further, the second port is in fluid communication with a second chamber port of the swing motor and the tank, or a second working position, where the first port is in fluid communication with the first chamber port of the swing motor and the tank and the second port is in fluid communication with the second chamber port of the swing motor and the pump.

The hydraulic control system includes a first conduit and a second conduit. The first conduit is coupled between the first port of the swing control valve and the first chamber port of the swing motor. Further, the second conduit is coupled between the second port of the swing control valve and the second chamber port of the swing motor. A first chamber valve and a second chamber valve coupled to the first conduit and the second conduit. An accumulator fluidly coupled to each of the first and second conduits and configured to selectively receive a pressurized fluid discharged from the swing motor. A controller configured to determine a charge mode for the accumulator, wherein during the charge mode the controller is configured to selectively move the swing control valve away from one of the first and the second working positions. Further, the controller selectively move one of the first and second chamber valves to reduce the fluid flow between the swing motor and the tank such that the pressurized flow discharged from the swing motor is directed to the accumulator.

In another aspect, the present disclosure is directed to a method of operating a hydraulic circuit in the hydraulic control system. The method includes determining the charge mode of operation with the controller and selectively moving the swing control valve away from one of its first and second working positions. Further, the controller selectively moves one of a first chamber valve and a second chamber valve to reduce the fluid flow between the pump and the swing motor such that a pressurized flow discharged from the swing motor is directed to the accumulator.

### BRIEF DESCRIPTION OF THE DRAWINGS

FIG. 1 is a diagrammatic illustration of an exemplary disclosed machine operating at a worksite with a haul vehicle;

FIG. 2 is a schematic illustration of an exemplary disclosed hydraulic control system that may be used with the machine of FIG. 1; and

FIG. 3 is a flowchart depicting an exemplary disclosed method that may be performed by the hydraulic control system of FIG. 2.

### DETAILED DESCRIPTION

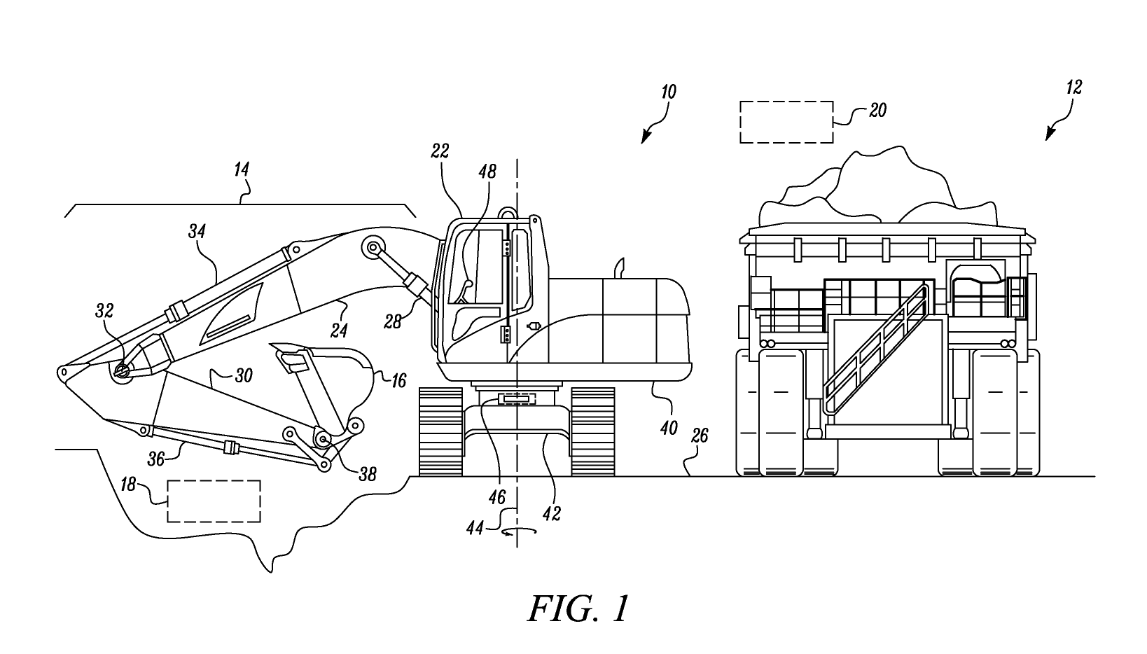

FIG. 1 illustrates an exemplary machine 10 having multiple systems and components that cooperate to excavate and load earthen material onto a nearby haul vehicle 12. In the depicted example, the machine 10 is a hydraulic excavator. It is contemplated, however, that the machine 10 could alternatively embody any other swing-type excavation or material handling machine, such as a backhoe, a front shovel, a dragline excavator, or another similar machine. The machine 10 may include, among other things, an implement system 14 configured to move a work tool 16 between a dig location 18 within a trench or at a pile, and a dump location 20, for example the over haul vehicle 12. The machine 10 may also include an operator station 22 for control of the implement system 14. It is contemplated that the machine 10 may perform operations other than material loading, if desired, such as craning, trenching, and material handling.

The implement system 14 may include a linkage structure operated on by fluid actuators to move the work tool 16. For example, the implement system 14 may include a boom 24 that is vertically pivotal relative to a work surface 26 by a pair of, double-acting, hydraulic cylinders 28 (only one shown in FIG. 1). The implement system 14 may also include a stick 30 that is vertically pivotal about a horizontal pivot axis 32 relative to the boom 24 by a single, double-acting, hydraulic cylinder 34. The implement system 14 may further include a single, double-acting, hydraulic cylinder 36 that is operatively connected to the work tool 16 to tilt the work tool 16 vertically about a horizontal pivot axis 38 relative to the stick 30. The boom 24 may be pivotally connected to a frame 40 of the machine 10, while the frame 40 may be pivotally connected to an undercarriage member 42 and adapted to swing about a vertical axis 44 by a swing motor 46. It is contemplated that a greater or lesser number of fluid actuators may be included within the implement system 14 and connected in a manner other than described above, if desired.

Numerous different work tools 16 may be attachable to the implement system 14 and controllable via the operator station 22. The work tool 16 may include any device such as, for example, a bucket, a fork arrangement, a blade, a shovel, a crusher, a shear, a grapple, a grapple bucket, a magnet, or any other material handling device known in the art. The operator station 22 may be configured to receive one or more inputs from a machine operator indicative of a desired work tool movement. Specifically, the operator station 22 may include one or more input devices 48 embodied, for example, as single or multi-axis joysticks located proximal to an operator seat (not shown). The input devices 48 may be proportional-type controllers configured to position and/or orient the work tool 16 by producing a work tool position signal that is indicative of a desired work tool speed and/or force in a particular direction. The position signal may be used to actuate any one or more of the hydraulic cylinders 28, 34, 36 and/or the swing motor 46. It is contemplated that different input devices may alternatively or additionally be included within the operator station 22 such as, for example, wheels, knobs, push-pull devices, switches, pedals, and other operator input devices known in the art.

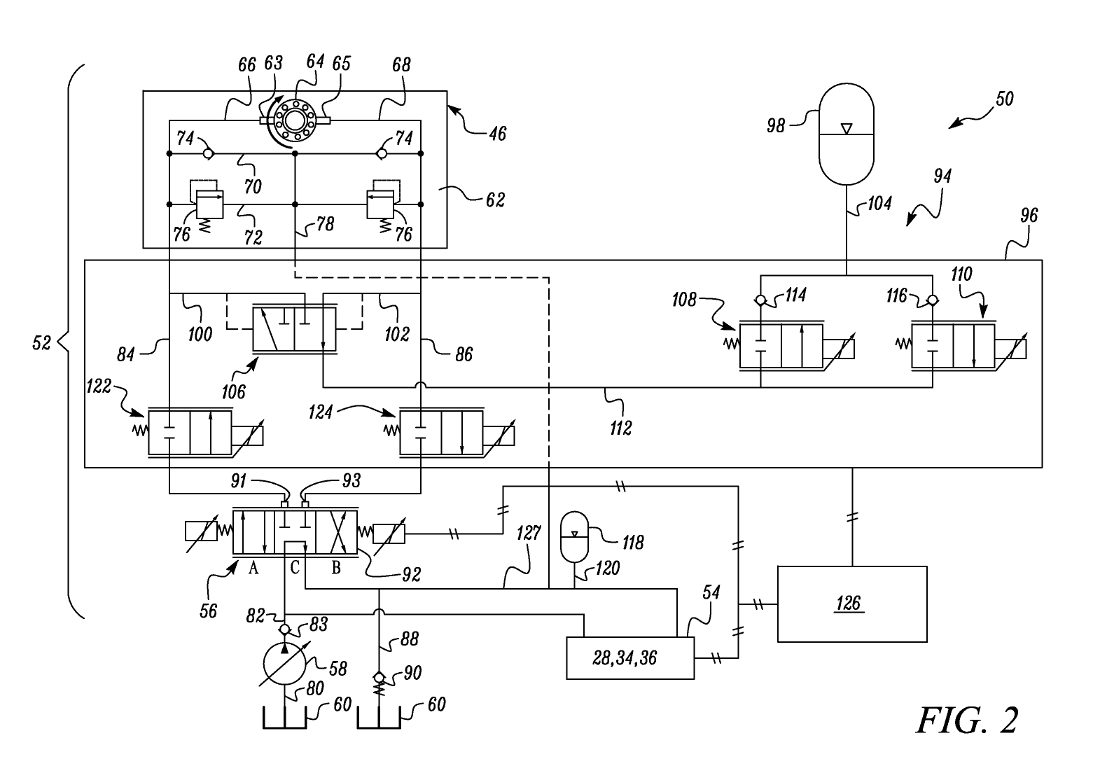

As illustrated in FIG. 2, the machine 10 may include a hydraulic control system 50 having a plurality of fluid components that cooperate to move the implement system 14 (referring to FIG. 1). In particular, the hydraulic control system 50 may include a first circuit 52 associated with the swing motor 46, and at least one second circuit 54 associated with the hydraulic cylinders 28, 34, and 36. The first circuit 52 may include, among other things, a swing control valve 56 to selectively control a flow of pressurized fluid from a pump 58 to the swing motor 46 and from the swing motor 46 to a low-pressure tank 60 to cause a swinging movement of the implement system 14 about the vertical axis 44 (referring to FIG. 1). The second circuit 54 may include similar control valves, for example a boom control valve (not shown), a stick control valve (not shown), a work tool control valve (not shown), a travel control valve (not shown), and/or an auxiliary control valve connected in parallel to receive pressurized fluid from the pump 58 and to discharge fluid to the tank 60, thereby regulating the corresponding fluid actuators (e.g., the hydraulic cylinders 28, 34, and 36).

The swing motor 46 may include a housing 62 at least partially forming a first and a second chamber ports 63 and 65 located to either side of an impeller 64. When the first chamber port 63 is connected to an output of the pump 58 (e.g., via a first chamber passage 66 formed within the housing 62) and the second chamber port 65 is connected to the tank 60 (e.g., via a second chamber passage 68 also formed within the housing 62), the impeller 64 may be driven to rotate in a first direction (shown in FIG. 2). Conversely, when the first chamber port 63 is connected to the tank 60 via the first chamber passage 66 and the second chamber port 65 is connected to the pump 58 via the second chamber passage 68, the impeller 64 may be driven to rotate in an opposite direction (not shown). The flow rate of fluid through the impeller 64 may relate to a rotational speed of the swing motor 46, while a pressure difference across the impeller 64 may relate to an output torque thereof.

The swing motor 46 may include built-in make up and relief capabilities. As illustrated, a make up passage 70 and a relief passage 72 may be formed within the housing 62, between the first chamber passage 66 and the second chamber passage 68. A pair of opposing check valves 74 and a pair of opposing relief valves 76 may be disposed within the make up and the relief passages 70, 72, respectively. Further, a low-pressure passage 78 may be connected to each of the make up and the relief passages 70, 72 at locations between the check valves 74 and between the relief valves 76. Moreover, during a normal make up mode, based on a pressure difference between the low-pressure passage 78 and the first and the second chamber passages 66, 68, one of the check valves 74 may open to allow fluid from the low-pressure passage 78 into the lower-pressure one of the first and the second chamber passages 66, 68 and thus inhibit voiding of the swing motor 46. Similarly, based on the pressure difference between the first and the second chamber passages 66, 68 and the low-pressure passage 78, one of the relief valves 76 may open to allow fluid from the higher-pressure one of the first and the second chamber passages 66, 68 into the low-pressure passage 78.

The pump 58 may be configured to draw fluid from the tank 60 via an inlet passage 80, pressurize the fluid to a desired level, and discharge the fluid to the first and the second circuits 52, 54 via a discharge passage 82. A check valve 83 may be disposed within the discharge passage 82, if desired, to provide a unidirectional flow of pressurized fluid from the pump 58 into the first and the second circuits 52, 54. The pump 58 may embody, for example, a variable displacement pump (as shown in FIG. 2), a fixed displacement pump, or another source known in the art. The pump 58 may be drivably connected to a power source (not shown) of the machine 10 by, for example, a countershaft (not shown), a belt (not shown), an electrical circuit (not shown), or in another suitable manner. Alternatively, the pump 58 may be indirectly connected to the power source of the machine 10 via a torque converter, a reduction gear box, an electrical circuit, or in any other suitable manner. The pump 58 may produce a stream of pressurized fluid having a pressure level and/or a flow rate determined, at least in part, by demands of the actuators within the first and the second circuits 52, 54. The discharge passage 82 may be selectively connected to the first and the second chamber passages 66, 68, within the first circuit 52, by the swing control valve 56 via first and second conduits 84, 86, respectively. The first and the second conduits 84, 86 may be coupled between the first and the second ports 91, 93 of the swing control valve 56 and the first chamber and the second chamber ports 63, 65 of the swing motor 46, respectively.

The tank 60 may constitute a reservoir configured to hold a low-pressure supply of fluid. The fluid may include, for example, hydraulic oil, engine lubrication oil, transmission lubrication oil, or any other fluid known in the art. It is contemplated that the hydraulic control system 50 may be connected to multiple separate fluid tanks or to a single tank, as desired. The tank 60 may be fluidly connected to the swing control valve 56 via a drain passage 88, and to the first and the second chamber passages 66, 68 via the swing control valve 56 and the first and the second conduits 84, 86, respectively. The tank 60 may also be connected to the low-pressure passage 78. A check valve 90 may be disposed within drain passage 88, if desired, to promote a unidirectional flow of fluid into the tank 60.

According to an aspect of the present disclosure, the swing control valve 56 may be a directional control valve to start, stop or change the flow of the pressurized fluid and control the rotation of swing motor 46. In an embodiment, the swing control valve 56 may be a three-position valve having a first port 91 and a second port 93. To this end, the swing control valve 56 may be biased in one of the positions, such as a neutral position C, with a spring biased valve element 92, provided within a housing. The valve element 92 is movable between a first working position A, wherein the first port 91 is in fluid communication with the first chamber port 63 of the swing motor 46 and the pump 58 and the second port 93 is in fluid communication with the second chamber port 65 of the swing motor 46 and the tank 60, a second working position B, wherein the first port 91 is in fluid communication with the first chamber port 63 of the swing motor 46 and the tank 60 and the second port 93 is in fluid communication with the second chamber port 65 of the swing motor 46 and the pump 58, and in the neutral position C, wherein the flow from the pump 58 to the swing motor 46 is inhibited.

In an embodiment, the swing control valve 56 may be a proportional directional control single spool-type valve slidably disposed within a housing, including a control spool, biasing members, and proportional solenoids. In one example, the swing control valve 56 is a solenoid operated, variable position, four-way, three-position valve. The swing control valve 56 can be operated by a controller, such as integrated electronics or a suitable amplifier, such that an increased current in the proportional solenoids increases magnetic force to push the spool against the opposing spring. The spool may have a series of metering slots which control flows of the fluid in the first circuit 52, including a flow from the pump 58 to the swing motor 46 and a flow from the swing motor 46 to the tank 40.

To drive the swing motor 46 to rotate in the first direction (shown in FIG. 2), the swing control valve 56 may be shifted to the first working position A to allow the pressurized fluid from the pump 58 to enter the first chamber port 63 of the swing motor 46 via the first conduit 84, and allow the fluid from the second chamber port 65 of the swing motor 46 to drain into the tank 60 via the second conduit 86 and the drain passage 88. To drive the swing motor 46 to rotate in the opposite direction, the swing control valve 56 may be shifted to the second working position B to connect the second chamber port 65 of the swing motor 46 with the pressurized fluid from the pump 58, while draining of fluid from the first chamber port 63 of the swing motor 46 to the tank 60.

The hydraulic control system 50 may be fitted with an energy recovery arrangement (ERA) 94 that is in communication with at least the first circuit 52 and configured to selectively extract and recover energy from the fluid that is discharged from or supplied to the swing motor 46. The ERA 94 may include, among other things, a recovery valve block (RVB) 96 that is fluidly connectable between the pump 58 and the swing motor 46, and an accumulator 98 configured to selectively communicate with the swing motor 46 via the RVB 96. The RVB 96 may be fixedly and mechanically connectable to one or both of the swing control valve 56 and the swing motor 46. The RVB 96 may include a first internal passage 100 fluidly connectable to the first conduit 84, and a second internal passage 102 fluidly connectable to the second conduit 86. The accumulator 98 may be fluidly coupled to each of the first and the second conduits 84, 86 via the RVB 96 and a conduit 104.

The RVB 96 may house one or more of a selector valve 106, a charge valve 108, and a discharge valve 110 disposed in parallel with the charge valve 108 and associated with the accumulator 98. The selector valve 106 may fluidly communicate one of the first and the second internal passages 100, 102 with the charge and the discharge valves 108, 110 based on a pressure of the first and the second internal passages 100, 102. The charge and the discharge valves 108, 110 may be selectively movable to fluidly communicate the accumulator 98 with the selector valve 106 for fluid charging and discharging purposes.

The selector valve 106 may be a pilot-operated, two-position, three-way valve that is movable in response to fluid pressures in the first and the second internal passages 100, 102 (i.e., in response to a fluid pressures within the first and second chamber ports 63, 65 of the swing motor 46). The selector valve 106 may be movable between a first position at which the first internal passage 100 is fluidly connected to the charge and the discharge valves 108, 110 via an internal passage 112, and a second position (shown in FIG. 2) at which the second internal passage 102 is fluid connected to the charge and the discharge valves 108, 110 via the internal passage 112.

The charge valve 108 and the discharge valve 110 may be solenoid-operated, variable position, two-way valves that are movable to allow fluid from the internal passage 112 to enter into or discharge from the accumulator 98. A check valve 114 may be disposed between the charge valve 108 and the accumulator 98 to provide a unidirectional flow of fluid into the accumulator 98. Similarly, a check valve 116 may be disposed between the accumulator 98 and the discharge valve 110 to provide a unidirectional flow of fluid from the accumulator 98 into the internal passage 112.

According to an embodiment of the present disclosure, an auxiliary accumulator 118 is also configured to selectively and directly communicate with the swing motor 46. The auxiliary accumulator 118 may be fluidly connectable to the swing motor 46 via the low-pressure and the drain passages 78 and 88, in parallel with the tank 60, via a conduit 120. The accumulators 98, 118 may each embody pressure vessels filled with a compressible gas that are configured to store pressurized fluid for use by the swing motor 46. The compressible gas may include, for example, nitrogen, argon, helium, or another appropriate compressible gas. As fluid in communication with the accumulators 98, 118 exceeds predetermined pressures of the accumulators 98, 118, the fluid may flow into the accumulators 98, 118. Because the gas therein is compressible, it may act like a spring and compress as the fluid flows into the accumulators 98, 118. When the pressure of the fluid within the conduits 104, 120 drops below the predetermined pressures of the accumulators 98, 118, the compressed gas may expand and urge the fluid from within the accumulators 98, 118 to exit. It is contemplated that the accumulators 98, 118 may alternatively embody other energy storage devices such as, for example, membrane/spring-biased or bladder types of accumulators, if desired.

In the disclosed embodiment, the accumulator 98 may be a larger (i.e., about 5-20 times larger) and the higher-pressure (i.e., about 5-60 times higher-pressure) accumulator, as compared to the auxiliary accumulator 118. Specifically, the accumulator 98 may be configured to accumulate up to about 50-100 L of fluid having a pressure in the range of about 260-300 bar, while the auxiliary accumulator 118 may be configured to accumulate up to about 10-20 L of fluid having a pressure in the range of about 5-30 bar. The accumulator 98 may be used primarily to assist the motion of the swing motor 46 and to improve machine efficiencies, while the auxiliary accumulator 118 may be used primarily as a make up accumulator to help reduce a likelihood of voiding at the swing motor 46. It is contemplated, however, that other volumes and pressures may be accommodated by the either of the accumulators 98, 118, if desired.

According to an embodiment of the present disclosure, the RVB 96 houses a first chamber valve 122 and a second chamber valve 124 may be coupled to the first conduit 84 and the second conduit 86, respectively. As shown, the first and/or second chamber valves 122, 124 may be configured as a two-way, two-position valve. According to an embodiment of the present disclosure, the first chamber valve 122 and the second chamber valve 124 may be solenoid operated, variable position, valves configured to selectively move between an open position and a closed position (the closed position is shown in FIG. 2) to block the first conduit 84 and the second conduit 86. During the rotation of the swing motor 46, both of the first chamber valve 122 and the second chamber valve 124 may be selectively kept in the open position to allow the first conduit 84 or the second conduit 86 to be in fluid communication with the swing control valve 56.

The swing control valve 56, the charge valve 108, the discharge valve 110, the first chamber valve 122, and the second chamber valve 124 may be movable in response to a flow rate and/or position command issued by a controller 126. In particular, the swing motor 46 may rotate at a velocity that corresponds with the flow rate of fluid into and out of the first and second chamber ports 63, 65. Accordingly, to achieve an operator-desired swing torque, a command may be sent to the swing control valve 56 to move either of the first working position A or the second working position B. This command may be in the form of a flow rate command or a valve element position command that is issued by the controller 126.

Further, the controller 126 may be configured to determine a charge mode and a discharge mode for the accumulator 98, thereby improving performance of the machine 10. In particular, a typical swinging motion of the implement system 14 instituted by the swing motor 46 may consist of a period of time during which the swing motor 46 is accelerating a swinging movement of the implement system 14, and a period of time during which the swing motor 46 is decelerating the swinging movement of the implement system 14. The acceleration segments may require significant energy from the swing motor 46 that is conventionally realized by way of the pressurized fluid supplied to the swing motor 46 by the pump 58, while the deceleration segments may produce significant energy in the form of pressurized fluid that is conventionally wasted through discharge to the tank 60. Both the acceleration and the deceleration segments may require the swing motor 46 to convert significant amounts of hydraulic energy to swing kinetic energy, and vice versa. The pressurized fluid passing through the swing motor 46 during deceleration, however, still contains a large amount of energy. If the fluid passing through the swing motor 46 is selectively collected within the accumulator 98 during the deceleration segments (i.e., the charge mode), this energy can then be returned to and reused by the swing motor 46 during the ensuing acceleration segments (i.e., the discharge mode). In the discharge mode, the swing motor 46 can be assisted during the acceleration segments by selectively causing the accumulator 98 to discharge pressurized fluid into the higher-pressure chamber of the swing motor 46 (via the discharge valve 110, the internal passage 112, the selector valve 106, and the appropriate one of the first and the second conduits 84, 86), combinable with high-pressure fluid from the pump 58, thereby propelling the swing motor 46 at the same or greater rate with less pump power than otherwise possible via the pump 58 alone.

In the charge mode, the swing motor 46 can be assisted during the deceleration segments by selectively causing the accumulator 98 to charge with fluid exiting the swing motor 46, thereby providing additional resistance to the motion of the swing motor 46 and lowering a restriction and cooling requirement of the fluid exiting the swing motor 46. As described above, during the normal make up mode, the fluid leaving the swing motor 46 may allow fluid from the low-pressure passage 78 into the lower-pressure one of the first and the second chamber passages 66, 68 and vice versa. However, during the charge mode the fluid leaving the swing motor 46 may be directed to the accumulator 98, thus the auxiliary accumulator 118 discharges through the low pressure passage 78 and then through appropriate one of the check valve 74 to provide a make up flow. During the charge mode the controller 126 is configured to maintain the swing control valve 56 in the neutral position for the period of time to allow the auxiliary accumulator 118 to discharge pressurized fluid to one of the first and second chamber ports 63, 65 of the swing motor 46 to inhibit voiding of the swing motor 56. After the period of time, the controller 126 selectively move the swing control valve 56 toward one of the first and the second working positions A or B and move one of the first and second chamber valves 122, 124 to allow the fluid flow between the pump 58 and the swing motor 46 to further inhibit voiding of the swing motor 46. It will apparent to a person having ordinary skill in the art that the auxiliary accumulator 118 may be charged from a back pressure created when the swing control valve 56 is in the neutral position and the pressurized flow from the pump 58 is going to the tank 60 via a hydraulic line 127.

In an alternative embodiment, the controller 126 may be configured to selectively control charging of the accumulator 98 with fluid exiting the pump 58, as opposed to fluid exiting the swing motor 46. That is, during a peak-shaving or economy mode of operation, the controller 126 may be configured to cause the accumulator 98 to be charged with fluid exiting the pump 58 (e.g., via the swing control valve 56, the appropriate one of the first and the second conduits 84, 86, the selector valve 106, the internal passage 112, and the charge valve 108) when the pump 58 has excess capacity (i.e., a capacity greater than required by the first and the second circuits 54, 56 to move the implement system 14 as requested by the operator). Then, during times when the pump 58 has insufficient capacity to adequately power the swing motor 46, the high-pressure fluid previously collected from the pump 58 in the accumulator 98 may be discharged in the manner described above to assist the swing motor 46.

Moreover, the controller 126 may be in communication with the different components of the hydraulic control system 50 to regulate operations of the machine 10. For example, the controller 100 may be in communication with the elements of control valves (not shown) associated with the second circuit 54. Based on various operator input and monitored parameters the controller 126 may be configured to selectively activate the different control valves in a coordinated manner to efficiently carry out operator requested movements of the implement system 14.

The controller 126 may include a memory, a secondary storage device, a clock, and one or more processors that cooperate to accomplish a task consistent with the present disclosure. Numerous commercially available microprocessors can be configured to perform the functions of the controller 126. It should be appreciated that the controller 126 could readily embody a general machine controller capable of controlling numerous other functions of the machine 10. Various known circuits may be associated with the controller 126, including signal-conditioning circuitry, communication circuitry, and other appropriate circuitry. It should also be appreciated that the controller 126 may include one or more of an application-specific integrated circuit (ASIC), a field-programmable gate array (FPGA), a computer system, and a logic circuit configured to allow the controller 126 to function in accordance with the present disclosure.

### INDUSTRIAL APPLICABILITY

The disclosed hydraulic control system may be applicable to any excavation machine which involves swinging movements of an implement system. The disclosed hydraulic control system may help to improve machine performance and efficiency by assisting swinging acceleration and deceleration of the implement system with an accumulator.

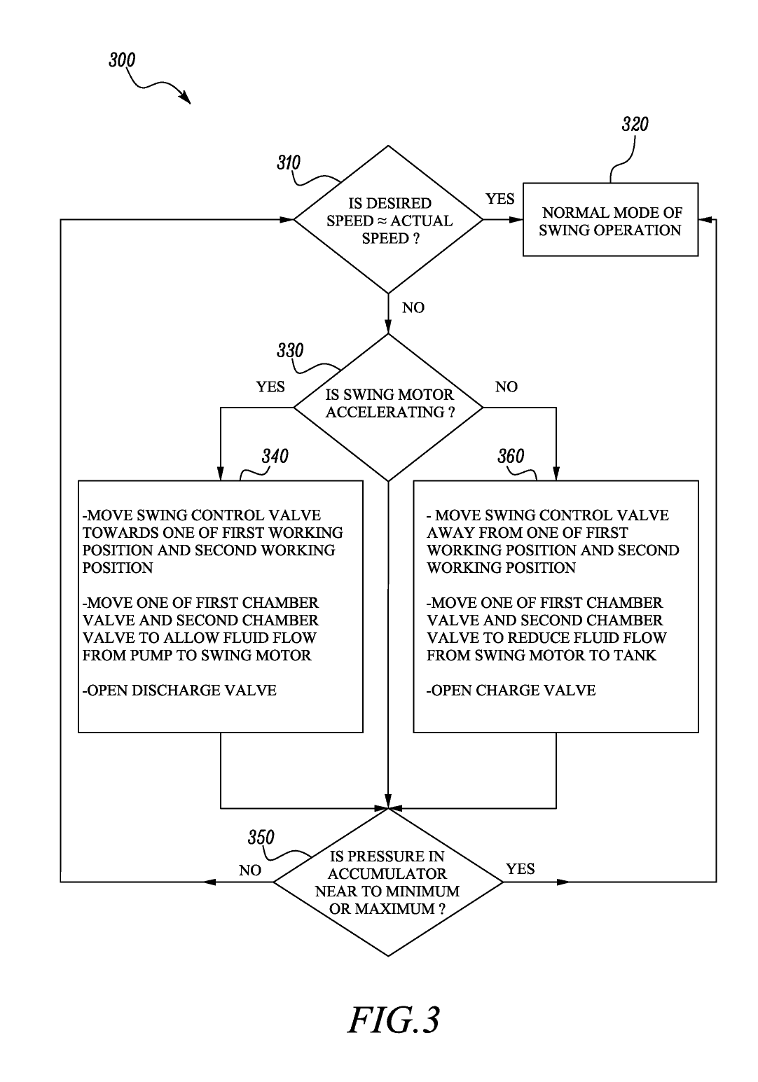

According to an embodiment of the present disclosure, the controller 126 may receive input indicative of a desired speed of the swing motor 46, an actual speed of the swing motor 46, and a pressure difference across the swing motor 46. The input indicative of the desired speed of the swing motor 46 may be a signal generated by the input device 48, while the input indicative of actual speed may be a signal generated by one or more performance sensors associated with the swing motor 46. Further, the input indicative of the pressure difference across the swing motor 46 may include signals generated by pressure sensors associated with the first and the second conduits 84, 86 in the first circuit 52. Operation of the disclosed hydraulic control system 50 is described in detail with reference to FIG. 3.

FIG. 3 illustrates an exemplary flowchart 300 disclosing operation of the hydraulic control system 50. At step 310, the controller 126 may determine if the desired speed is substantially equal to (i.e., within a threshold limit) the actual speed. In case the difference between the desired speed and the actual speed is small (Step 310: YES), the controller 126 may conclude that use of the accumulator 98 is unwarranted (i.e., that charging or discharging of the accumulator 98 would either not be possible or would be inefficient) and follow a normal mode of swing operation using the pump 58 to move the implement system 14 at step 320. In the normal mode of swing operation, the controller 126 may selectively move the swing control valve 56 towards one of the first working position A or the second working position B (depending on the rotational direction of the swing motor 46). Further, the first and the second chamber valves 122 and 124 are maintained in the open positions to regulate flows of the fluid from the pump 58 to the swing motor 46 and from the swing motor 46 to the tank 60.

In case, when the pressure difference is large, the swing motor 46 may either be undergoing acceleration or deceleration, which corresponds to a significant difference between the desired and actual speeds of the swing motor 46 (Step 310: NO), the controller 126 may determine whether the swing motor 46 is accelerating or decelerating at step 330. The controller 126 may determine whether the swing motor 46 is accelerating or decelerating based on the pressure difference across the swing motor 46, the desired speed of the swing motor 46, and the actual speed of the swing motor 46. For example, when the desired speed is in the same direction as and larger than the actual speed and the pressure difference across the swing motor 46 is large, the swing motor 46 is accelerating. In contrast, when the desired speed is in the same direction as and less than the actual speed (or in a direction opposing the actual speed), and the pressure difference is large, the swing motor 46 is decelerating.

When the controller 126 determines that the swing motor 46 is accelerating (Step 330: YES), the controller 126 may determine the discharge mode for the accumulator 98 and utilize pressurized fluid stored in the accumulator 98 to assist the movement of the implement system 14. In particular, the controller 126 may selectively move the swing control valve 56 towards one of the first working position A or the second working position B (depending on the rotational direction of the swing motor 46) to increase the fluid flow from the pump 58 to the swing motor 46, and selectively move the appropriate one of the first and the second chamber valves 122, 124 to allow the fluid flow between the pump 58 and the swing motor 46. Simultaneously, the discharge valve 110 is opened to supply the pressurized flow discharged from the accumulator 98 to the swing motor 46 at step 340. It should be noted that the movement of one of the first or the second chamber valves 122, 124 may be coordinated with the opening of the discharge valve 110, such that the pressurized flow discharged from the accumulator 98 is combinable with the fluid flow provided from the pump 58 to the swing motor 46. In this manner, the motion of the swing motor 46 may be continuous and substantially unaffected by the combining the supply sources.

While supplying fluid from the accumulator 98 to the swing motor 46, the controller 126 may monitor the pressure of fluid within the accumulator 98 and compare the monitored pressure to a one or more pressure thresholds (e.g., to a minimum pressure threshold during acceleration) at step 350. If the pressure of fluid within the accumulator 98 passes through the appropriate pressure threshold (Step 350: YES, e.g., when the pressure of the fluid within the accumulator 98 reaches or falls below the minimum pressure threshold during acceleration), the operation may return to step 320 where operation may transition to the normal mode of swing operation. In this situation, the capacity of the accumulator 98 to provide fluid may have been nearly or completely exhausted, and the pump 58 should be used to continue the swinging motion of the implement system 14. Otherwise (Step 350: NO), the operation may loop back to step 310.

If at step 330, the controller 126 determines that the swing motor 46 is decelerating (Step 330: NO), the controller 126 may determine the charge mode for the accumulator 98 and use the accumulator 98 to slow the implement system 14 and to simultaneously capture otherwise wasted energy in the form of stored pressurized fluid. In particular, the controller 126 may selectively move the swing control valve 56 away from one of the first working position A or the second working position B to reduce the fluid flow from the pump 58 to the swing motor 46, and selectively move the appropriate one of the first and the second chamber valves 122, 124 to reduce the fluid flow between the swing motor 46 and the tank 60. Simultaneously, the charge valve 108 is opened to direct the pressurized fluid from the swing motor 46 into the accumulator 98 for storage at step 360. As the fluid enters the accumulator 98, the pressure within the accumulator 98 and in the passages leading back to the swing motor 46 may increase, thereby providing resistance to the rotation of the swing motor 46 and slowing the swing motor 46. It should be noted that the gradual movement of one of the first or the second chamber valves 122, 124 may be coordinated with the gradual opening of the charge valve 108, such that the reduction in flow into the tank 60 may be accommodated by an increased flow into the accumulator 98. In this manner, the motion of the swing motor 46 may be continuous and substantially unaffected by the change in collection reservoirs.

While directing fluid into the accumulator 98 from the swing motor 46 during deceleration, the controller 126 may monitor the pressure of fluid within the accumulator 98 and compare the monitored pressure to a one or more pressure thresholds (e.g., to a maximum pressure threshold during deceleration) at step 350. If the pressure of fluid within the accumulator 98 passes through the appropriate pressure threshold (Step 350: YES, e.g., when the pressure of the fluid within the accumulator 98 reaches or exceeds the maximum pressure threshold during deceleration), the operation may return to step 320 where operation will transition to the normal mode of swing operation. In this situation, the capacity of the accumulator 98 to receive fluid will have been nearly or completely exhausted, and the tank 60 should be used to consume the return fluid and continue the swinging motion of the implement system 14. Otherwise (Step 350: NO), the operation may loop back to step 310.

Several benefits may be associated with the disclosed hydraulic control system. First, the hydraulic control system 50 utilizes a high-pressure accumulator and a low-pressure accumulator (i.e., the accumulators 98, 118), such that fluid discharged from the swing motor 46 during acceleration may be also recovered within the auxiliary accumulator 118. Second, use of the single spool directional control valve as the swing control valve 56, the first chamber valve 122 and the second chamber valve 124 may reduces complexity and associated cost of the hydraulic control system 50. Third, the auxiliary accumulator 118 may help to reduce the likelihood of voiding at swing motor 46 during the charge mode and also make-up for the any lost fluid in swing control valve 56 due to internal leakage. Finally, use of the disclosed method implemented by the controller 126 during energy recovery, may result in smooth or even seamless transition between pump-assisted and accumulator-assisted operations. This double recovery of energy may help to increase the efficiency of the machine 10.

It will be apparent to those skilled in the art that various modifications and variations can be made to the disclosed hydraulic control system. Other embodiments will be apparent to those skilled in the art from consideration of the specification and practice of the disclosed hydraulic control system. It is intended that the specification and examples be considered as exemplary only, with a true scope being indicated by the following claims and their equivalents.

We claim:

1. A hydraulic control system for a machine having a swing motor, a pump, and a tank, comprising:
a swing control valve coupled between the swing motor and the pump and the tank to selectively control a fluid flow from the pump to the swing motor and from the swing motor to the tank, the swing control valve having a first port and a second port, the swing control valve movable from a neutral position, where the fluid flow is inhibited, to either a first working position, where the first port is in fluid communication with a first chamber port of the swing motor and the pump and the second port is in fluid communication with a second chamber port of the swing motor and the tank, or a second working position, where the first port is in fluid communication with the first chamber port of the swing motor and the tank and the second port is in fluid communication with the second chamber port of the swing motor and the pump;
a first conduit coupled between the first port of the swing control valve and the first chamber port of the swing motor;
a second conduit coupled between the second port of the swing control valve and the second chamber port of the swing motor;
a first chamber valve and a second chamber valve coupled to the first conduit and the second conduit, respectively;
an accumulator fluidly coupled to each of the first and second conduits and configured to selectively receive a pressurized fluid discharged from the swing motor; and
a controller configured to determine a charge mode for the accumulator, wherein during the charge mode the controller is configured to:
selectively move the swing control valve away from one of the first and the second working positions; and
selectively move one of the first and second chamber valves to reduce the fluid flow between the swing motor and the tank such that the pressurized flow discharged from the swing motor is directed to the accumulator.

2. The hydraulic control system of claim 1, further including an auxiliary accumulator fluidly coupled between the swing motor and the tank via a make up line.

3. The hydraulic control system of claim 2, wherein during the charge mode the controller is further configured to:
maintain the swing control valve in the neutral position for a period of time to allow the auxiliary accumulator to discharge pressurized fluid to one of the first and second chamber ports of the swing motor to inhibit voiding of the swing motor; and
after the period of time, selectively move the swing control valve toward one of the first and the second working positions and move one of the first and second chamber valves to allow the fluid flow between the pump and the swing motor to further inhibit voiding of the swing motor.

4. The hydraulic control system of claim 1, wherein the swing control valve is a single spool, solenoid operated, four-way, three-position valve.

5. The hydraulic control system of claim 1, wherein each of the first and second chamber valves is a solenoid operated, two-way, two-position valve.

6. The hydraulic control system of claim 1, further including a charge valve disposed between the swing motor and the accumulator, wherein during the charge mode the controller is configured to open the charge valve.

7. The hydraulic control system of claim 1, wherein the controller is configured to determine a discharge mode for the accumulator, wherein during the discharge mode the controller is configured to:
selectively move the swing control valve toward one of the first and the second working positions; and
selectively move one of the first and second chamber valves to allow the fluid flow between the pump and the swing motor, wherein the pressurized flow discharged from the accumulator is combinable with the fluid flow provided from the pump to the swing motor.

8. The hydraulic control system of claim 7, further including a discharge valve disposed between the swing motor and the accumulator, wherein during the discharge mode the controller is configured to open the discharge valve.

9. The hydraulic control system of claim 1, further including a selector valve to selectively couple the highest pressure of the first and second conduits to the accumulator.

10. A machine comprising:
a swing motor having a first chamber port and a second chamber port;
a pump;
a tank:
a swing control valve coupled between the swing motor and the pump and the tank to selectively control a fluid flow from the pump to the swing motor and from the swing motor to the tank, the swing control valve having a first port and a second port, the swing control valve movable from a neutral position, where the fluid flow is inhibited, to either a first working position, where the first port is in fluid communication with a first chamber port of the swing motor and the pump and the second port is in fluid communication with a second chamber port of the swing motor and the tank, or a second working position, where the first port is in fluid communication with the first chamber port of the swing motor and the tank and the second port is in fluid communication with the second chamber port of the swing motor and the pump;
a first conduit coupled between the first port of the swing control valve and the first chamber port of the swing motor;
a second conduit coupled between the second port of the swing control valve and the second chamber port of the swing motor;
a first chamber valve and a second chamber valve coupled to the first conduit and the second conduit, respectively;
an accumulator fluidly coupled to each of the first and second conduits and configured to selectively receive a pressurized fluid discharged from the swing motor; and
a controller configured to determine a charge mode for the accumulator, wherein during the charge mode the controller is configured to:
selectively move the swing control valve away from one of the first and the second working positions; and
selectively move one of the first and second chamber valves to reduce the fluid flow between the swing motor and the tank such that the pressurized flow discharged from the swing motor is directed to the accumulator.

11. The machine of claim 10, further including an auxiliary accumulator fluidly coupled between the swing motor and the tank via a make up line.

12. The machine of claim 11, wherein during the charge mode the controller is further configured to:
maintain the swing control valve in the neutral position for a period of time to allow the auxiliary accumulator to discharge pressurized fluid to one of the first and second chamber ports of the swing motor to inhibit voiding of the swing motor; and
after the period of time, selectively move the swing control valve toward one of the first and the second working positions and move one of the first and second chamber valves to allow the fluid flow between the pump and the swing motor to further inhibit voiding of the swing motor.

13. The machine of claim 10, wherein the swing control valve is a single spool, solenoid operated, four-way, three-position valve.

14. The machine of claim 10, wherein each of the first and second chamber valves is a solenoid operated, two-way, two-position valve.

15. The machine of claim 10, wherein the controller is configured to determine a discharge mode for the accumulator, wherein during the discharge mode the controller is configured to:
selectively move the swing control valve toward one of the first and the second working positions; and
selectively move one of the first and second chamber valves to allow the fluid flow between the pump and the swing motor, wherein the pressurized flow discharged from the accumulator is combinable with the fluid flow provided from the pump to the swing motor.

16. The machine of claim 15, further including a discharge valve disposed between the swing motor and the accumulator, wherein during the discharge mode the controller is configured to open the discharge valve; and a charge valve disposed between the swing motor and the accumulator in parallel with the discharge valve, wherein during the charge mode the controller is configured to open the charge valve.

17. A method of operating a hydraulic circuit, comprising:
determining a charge mode of operation of a hydraulic circuit having a swing motor, a pump, a tank, and an accumulator with a controller;
selectively moving a swing control valve away from one of its first and second working positions, the swing control valve coupled between the swing motor and the pump and the tank, the swing control valve having a first port and a second port, the swing control valve is movable from a neutral position to either the first working position, where the first port is in fluid communication with a first chamber port of the swing motor and the pump and the second port is in fluid communication with a second chamber port of the swing motor and the tank, or the second working position, where the first port is in fluid communication with the first chamber port of the swing motor and the tank and the second port is in fluid communication with the second chamber port of the swing motor and the pump; and
selectively moving one of a first chamber valve and a second chamber valve to reduce fluid flow between the swing motor and the tank such that a pressurized flow discharged from the swing motor is directed to the accumulator fluidly coupled to each of a first conduit and a second conduit, wherein the first chamber valve and the second chamber valve are coupled to the first conduit and the second conduit, respectively, the first conduit coupled between the first port of the swing control valve and the first chamber port of the swing motor, the second conduit coupled between the second port of the swing control valve and the second chamber port of the swing motor.

18. The method of claim 17, further including:
maintaining the swing control valve in its neutral position for a period of time to allow an auxiliary accumulator to discharge pressurized fluid to one of the first and second chamber ports of the swing motor to inhibit voiding of the swing motor, wherein the auxiliary accumulator is fluidly coupled between the swing motor and the tank via a make up line; and
after the period of time, selectively moving the swing control valve toward one of its first and second working positions and moving one of the first and second chamber valves to allow the fluid flow between the pump and the swing motor to further inhibit voiding of the swing motor.

19. The method of claim 17, further including:
determining a discharge mode for the accumulator;
selectively moving the swing control valve toward one of the first and the second working positions; and
selectively moving one of the first and second chamber valves to allow the fluid flow between the pump and the swing motor, wherein the pressurized flow discharged from the accumulator is combinable with the fluid flow provided from the pump to the swing motor.

20. The method of claim 19, further including selectively moving a charge valve disposed between the swing motor and the accumulator during the charge mode; and a discharge valve disposed between the swing motor and the accumulator during the discharge mode.
